(19) United States
(12) Patent Application Publication
(10) Pub. No.: US 2024/0078696 A1
(43) Pub. Date: Mar. 7, 2024

(54) SYSTEM AND METHOD FOR AUTOMATING A SCAN OF AN OBJECT

(71) Applicant: Leidos Security Detection & Automation, Inc., Tewksbury, MA (US)

(72) Inventors: Andrew D. Foland, Wellesley, MA (US); Gannon P. Gesiriech, Carlsbad, CA (US); Nicholas E. Ortyl, III, Bedford, MA (US)

(21) Appl. No.: 18/460,250

(22) Filed: Sep. 1, 2023

Related U.S. Application Data
(60) Provisional application No. 63/403,530, filed on Sep. 2, 2022.

(51) Int. Cl. G06T 7/70; G06T 7/50; G07C 9/10

(52) U.S. Cl. CPC G06T 7/70; G06T 7/50; G07C 9/10; G06T 2207/10028; G06T 2207/10048; G06T 2207/30196

(57) ABSTRACT

Systems and methods provide for performing a scan of an object is provided. A system includes a non-optical scanning device to perform the scan of the object. The system further includes an optical imaging device to capture image information about the object prior to performing the scan of the object. The system further includes a processing system comprising a memory comprising computer readable instructions and a processing device for executing the computer readable instructions. The computer readable instructions control the processing device to perform operations. The operations include determining whether a pose of the object satisfies a target pose. The operations further include, responsive to determining that the pose of the object satisfies the target pose, causing the non-optical scanning device to perform the scan of the object.

### RELATED APPLICATIONS

This application claims priority to U.S. Provisional Patent Application No. 63/403,530, filed on Sep. 2, 2022, which is hereby incorporated by reference in its entirety.

### BACKGROUND

Non-contact screening is an important tool to detect the presence of contraband or hazardous items being carried by an individual entering a restricted area or transportation hub such as a secure building, an airport, or a train station. Various technologies have been used for non-contact screening including x-ray and millimeter-wave imaging. Such technologies can be used to produce images that reveal hidden objects carried on a person that are not visible to plain sight.

### SUMMARY

According to some embodiments, a system for performing a scan of an object is provided. The system includes a non-optical scanning device to perform the scan of the object. The system further includes an optical imaging device to capture image information about the object prior to performing the scan of the object. The system further includes a processing system comprising a memory comprising computer readable instructions and a processing device for executing the computer readable instructions. The computer readable instructions control the processing device to perform operations. The operations include determining whether a pose of the object satisfies a target pose. The operations further include, responsive to determining that the pose of the object satisfies the target pose, causing the non-optical scanning device to perform the scan of the object.

According to some embodiments, a method for performing a scan of an object is provided. The method includes determining a pose of an object based at least in part on image information about the object captured using an optical imaging device. The method further includes comparing the pose of the object to a target pose. The method further includes, responsive to determining that the pose of the object fails to satisfy the target pose, providing feedback to correct the pose of the object prior to initiating the scan of the object. The method further includes, responsive to determining that the pose of the object satisfies the target pose, initiating the scan of the object, the scan being performed by a non-optical scanning device.

### BRIEF DESCRIPTION OF DRAWINGS

Illustrative embodiments are shown by way of example in the accompanying drawings and should not be considered as a limitation of the present disclosure.

FIG. 1 schematically illustrates a top view of a system for screening of individuals to detect hidden objects.

FIG. 2A schematically illustrates a computing device for use with some embodiments described herein.

FIG. 2B schematically illustrates a network environment for use with the systems and methods of some embodiments described herein.

FIG. 3 illustrates a block diagram of a system for performing a scan of an object responsive to determining that a pose of the object satisfies a target pose according to one or more embodiments described herein.

FIG. 4 illustrates an automated process of scanning an object is shown according to one or more embodiments described herein.

FIGS. 5A-5H illustrate an example of a procedure of the automated process of FIG. 7 according to one or more embodiments described herein.

FIG. 6 illustrates a data flow of generating pose feedback according to one or more embodiments described herein.

FIG. 7 illustrates a body joint estimation and merging method according to one or more embodiments described herein.

FIG. 8A and 8B illustrate examples of a scanning system used to control a scanning device according to one or more embodiments described herein.

FIG. 8C illustrates a block diagram of components of a machine learning training and inference system according to one or more embodiments described herein.

FIGS. 9A and 9B illustrate skeletal representations of an object overlaid with a visual representation of the target pose according to one or more embodiments described herein.

FIGS. 10A-10F illustrate interfaces according to one or more embodiments described herein.

FIGS. 11A and 11B illustrate a scanner that uses traffic flow devices according to one or more embodiments described herein.

FIG. 11C illustrates a scanner having a light curtain that provides e-gate functionality according to one or more embodiments described herein.

FIG. 12 illustrates a screening station including a resolution zone (or station) according to

one or more embodiments described herein.

FIG. 13 is a flow diagram of a computer-implemented method for performing a scan of an object (e.g., an individual) according to one or more embodiments described herein.

### DETAILED DESCRIPTION

Described in detail herein are systems and methods for non-invasive screening of objects for contraband. Particularly, one or more embodiments described herein provide for positioning an object for scanning. For example, in some embodiments the systems and methods employ full-body imaging systems that are configured to improve the scanning experience for the user while providing rapid throughput of individuals overall. High scanning throughput is desirable to reduce wait times for individuals awaiting screening. In conventional scanning systems, the object enters a chamber to be scanned. The object must maintain a target pose suitable for performing the scanning, such as while the scanner moves to cover multiple view angles around the object. The target pose of object must be communicated to each screened individual, and the time to complete an individual scan can increase if the individual requires additional help or re-instruction to achieve the pose.

Systems and methods of the present disclosure improve the user experience by performing, using a non-optical scanning device, a scan a body of an object responsive to determining, using an optical imaging device, that a pose of the object satisfies a target pose. One or more embodiments described herein provide for providing real-time instructions to an object to support the object achieving a target pose. As used herein, an object can refer to an individual, a vehicle, an animal, a box, a bag, and/or the like including any suitable object to be scanned. As used herein, an “individual” refers to a human/person. As used herein when used describing instructions or feedback, the phrase “real-time” refers to providing the instructions or feedback while an object (e.g., an individual) is preparing to be scanned and need not be instantaneous (e.g., a delay, such as for processing, may be present).

One or more of the embodiments described herein can be implemented in airport environments and/or non-airport environments. An operator that aids in the scanning operations described herein can be a security officer, such as a transportation security officer (TSO), or can be other than a security officer.

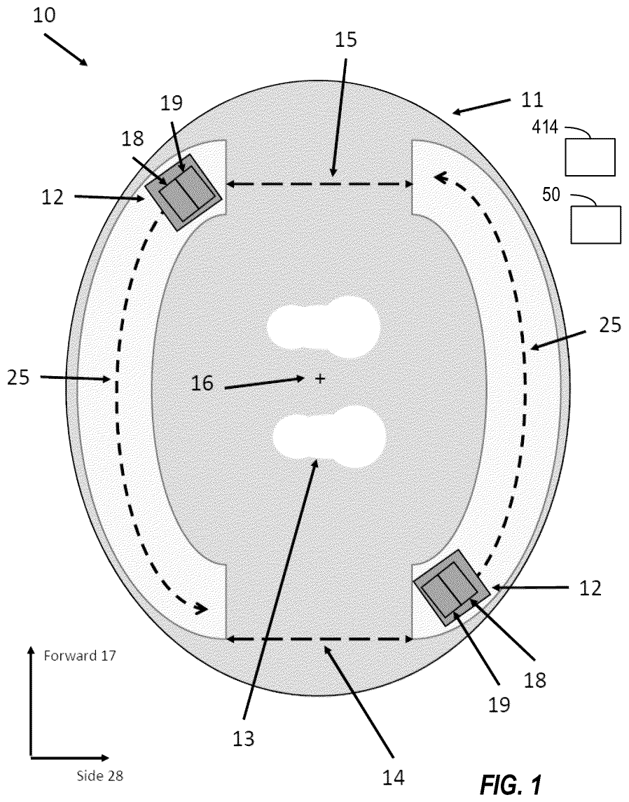

FIG. 1 illustrates a top-view of an exemplary system 10 for imaging an object according to conventional concepts. The object enters the imaging chamber 11 in a forward direction 17 through the entrance 14 and stands at or about a central point 16 in the chamber. Consider the following example for the object being an individual. The central point 16 can be indicated using instructional markings 13 to aid the individual in understanding how to stand for purposes of scanning such as footprint markings. The individual turns in a direction orthogonal to an axis that connects the entrance 14 and an exit 15 of the chamber 11. In other words, the individual turns 90°, often to the right, to face a side direction 28. Once the individual is in a correct location within the imaging camber 11, the individual assumes a scanning position, which is referred to as a pose. An example of a pose is as follows: The individual places his or her hands over his or her head. Other poses are also possible, such as the individual standing naturally in a relaxed stance with his or her arms at his or her side or with hands placed on hips. Once the individual is in the scanning position (e.g., has assumed the pose), two imaging masts 12 rotate around the individual on scan paths 25 as indicated by the arrows in FIG. 1.

The imaging masts 12 are connected in a “tuning fork” shaped configuration to a rigid central mount located in a roof of the chamber 11. Because the two imaging masts 12 are rigidly connected, they both rotate in a same direction, e.g., clockwise or counter-clockwise, and maintain a constant spacing distance between them. The imaging masts include both transmitters 18 and receivers 19. Each receiver 19 is spatially associated with a transmitter 18 such as by being placed in close proximity so as to form or act as a single point transmitter/receiver. In operation, the transmitters 18 sequentially transmit electromagnetic radiation one at a time that is reflected or scattered from the object, and the reflected or scattered electromagnetic radiation is received by two of the respective receivers 19. A computing device receives signals from the receivers 19 and reconstructs an image of the object using a monostatic reconstruction technique. Hidden objects or contraband may be visible on the image because the density or other material properties of the hidden object differ from organic tissue and create different scattering or reflection properties that are visible as contrasting features or areas on an image.

It should be appreciated that the system 10 is one of many different possible systems for scanning objects (e.g., individuals). The one or more embodiments described herein that provide for determining that a pose of the object satisfies a target pose can be used with any suitable style or configuration of scanner. For example, a walkthrough style scanner can be used, as taught in U.S. patent application Ser. No. 18/126,795, the contents of which are incorporated by reference herein in their entirety.

As shown in FIG. 1, the system 10 can include an optical imaging system 50. The optical imaging system 50 captures imaging information about of an object to be scanned. The imaging information is used to determine a pose of the object that can be compared to a target pose. In some embodiments, the optical imaging system 50 determines the pose of the object and compares it to the target pose. In other embodiments, the optical imaging system 50 can operate in conjunction with the computing device 150 or another suitable system to determine the pose of the object and compare the pose to the target pose. When the object's pose satisfies the target pose, the system 10 is triggered to perform a scan of the object. According to one or more embodiments described herein, the system 10 can include a visual display device 414 for displaying information, such as the pose of the object and/or the target pose. The visual display device 414 can be any suitable device for displaying information, such as a monitor, a projector, and/or the like including combinations and/or multiples thereof.

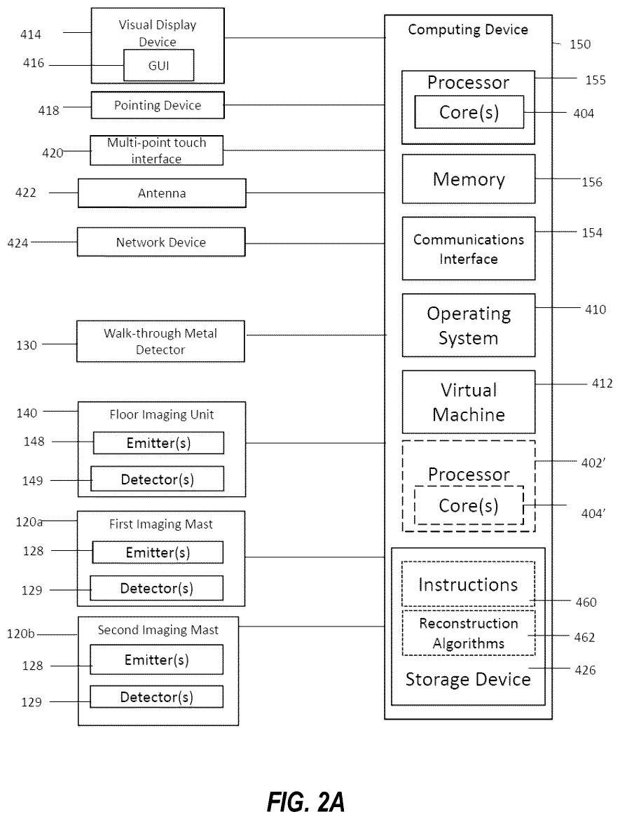

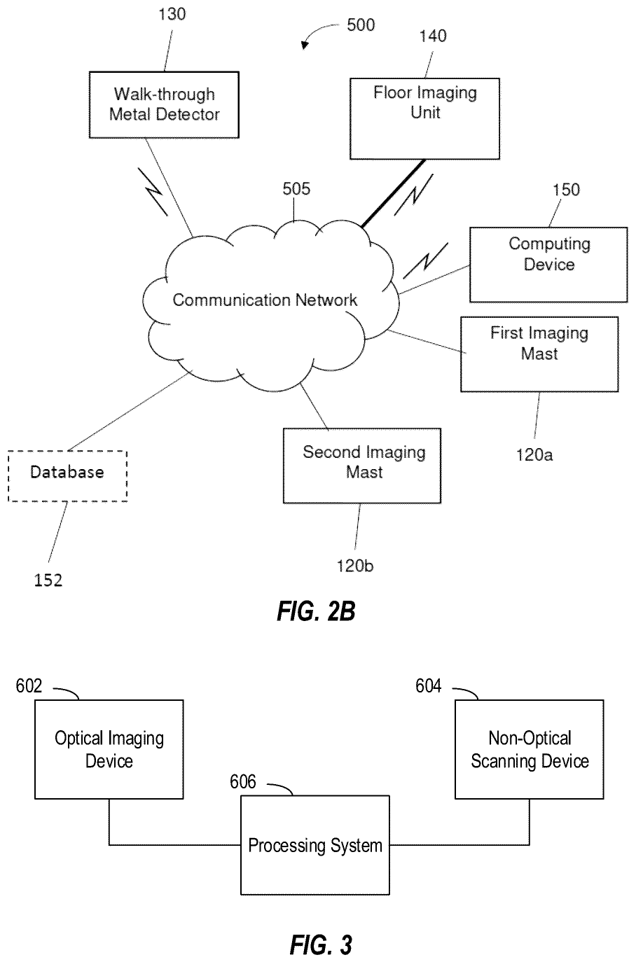

FIG. 2A is a block diagram of a computing device 150 suitable for use with embodiments of the present disclosure. The computing device 150 may be, but is not limited to, a smartphone, laptop, tablet, desktop computer, server, or network appliance. The computing device 150 includes one or more non-transitory computer-readable media for storing one or more computer-executable instructions or software for implementing the various embodiments taught herein. The non-transitory computer-readable media may include, but are not limited to, one or more types of hardware memory (e.g., memory 156), non-transitory tangible media (for example, storage device 426, one or more magnetic storage disks, one or more optical disks, one or more flash drives, one or more solid state disks), and the like. For example, memory 156 included in the computing device 150 may store computer-readable and computer-executable instructions 460 or software (e.g., instructions to receive data from receivers 129 of the imaging masts 120, data from receivers 149 of the floor imaging unit 140, or data from the non-invasive walk-through metal detector 130; instructions to perform image reconstruction methods using monostatic or multistatic reconstruction algorithms 462; etc.) for implementing operations of the computing device 150. The computing device 150 also includes configurable and/or programmable processor 155 and associated core(s) 404, and optionally, one or more additional configurable and/or programmable processor(s) 402′ and associated core(s) 404′ (for example, in the case of computer systems having multiple processors/cores), for executing computer-readable and computer-executable instructions or software stored in the memory 156 and other programs for implementing embodiments of the present disclosure. Processor 155 and processor(s) 402′ may each be a single core processor or multiple core (404 and 404′) processor. Either or both of processor 155 and processor(s) 402′ may be configured to execute one or more of the instructions described in connection with computing device 150.

Virtualization may be employed in the computing device 150 so that infrastructure and resources in the computing device 150 may be shared dynamically. A virtual machine 412 may be provided to handle a process running on multiple processors so that the process appears to be using only one computing resource rather than multiple computing resources. Multiple virtual machines may also be used with one processor.

Memory 156 may include a computer system memory or random access memory, such as DRAM, SRAM, EDO RAM, and the like. Memory 156 may include other types of memory as well, or combinations thereof.

A user may interact with the computing device 150 through a visual display device 414 (e.g., a computer monitor, a projector, and/or the like including combinations and/or multiples thereof), which may display one or more graphical user interfaces 416. The user may interact with the computing device 150 using a multi-point touch interface 420 or a pointing device 418.

The computing device 150 may also include one or more computer storage devices 426, such as a hard-drive, CD-ROM, or other computer readable media, for storing data and computer-readable instructions 460 and/or software that implement exemplary embodiments of the present disclosure (e.g., applications). For example, exemplary storage device 426 can include instructions 460 or software routines to enable data exchange with one or more imaging masts 120a, 120b, the floor imaging unit 140, or the non-invasive walk-through metal detector 130. The storage device 426 can also include reconstruction algorithms 462 that can be applied to imaging data and/or other data to reconstruct images of scanned objects.

The computing device 150 can include a communications interface 154 configured to interface via one or more network devices 424 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing device 150 can include one or more antennas 422 to facilitate wireless communication (e.g., via the network interface) between the computing device 150 and a network and/or between the computing device 150 and components of the system such as imaging masts 120, floor imager unit 140, or metal detector 130. The communications interface 154 may include a built-in network adapter, network interface card, PCMCIA network card, card bus network adapter, wireless network adapter, USB network adapter, modem or any other device suitable for interfacing the computing device 150 to any type of network capable of communication and performing the operations described herein.

The computing device 150 may run an operating system 410, such as versions of the Microsoft® Windows® operating systems, different releases of the Unix® and Linux® operating systems, versions of the MacOS® for Macintosh computers, embedded operating systems, real-time operating systems, open source operating systems, proprietary operating systems, or other operating system capable of running on the computing device 150 and performing the operations described herein. In exemplary embodiments, the operating system 410 may be run in native mode or emulated mode. In an exemplary embodiment, the operating system 410 may be run on one or more cloud machine instances.

FIG. 2B illustrates a network environment 500 including the computing device 150 and other elements of the systems described herein that is suitable for use with exemplary embodiments. The network environment 500 can include one or more databases 152, one or more imaging masts 120, 120a, 120b, one or more non-invasive walk-through metal receivers 130, one or more floor imaging units 140, and one or more computing devices 150 that can communicate with one another via a communications network 505.

The computing device 150 can host one or more applications (e.g., instructions 460 or software to communicate with or control imaging masts 120, transmitters 128, receivers 129, metal receivers 130, floor imaging units 140, floor transmitters 148, or floor receivers 149 and any mechanical, motive, or electronic systems associated with these system aspects; reconstruction algorithms 462; or graphical user interfaces 416) configured to interact with one or more components of the system 10 to facilitate access to the content of the databases 152. The databases 152 may store information or data including instructions 460 or software, reconstruction algorithms 462, or imaging data as described above. Information from the databases 152 can be retrieved by the computing device 150 through the communications network 505 during an imaging or scanning operation. The databases 152 can be located at one or more geographically distributed locations away from some or all system components (e.g., imaging masts 120, floor imaging unit 140, metal detector 130) and/or the computing device 150. Alternatively, the databases 152 can be located at the same geographical location as the computing device 150 and/or at the same geographical location as the system components. The computing device 150 can be geographically distant from the chamber 111 or other system components (masts 120, metal detector 130, floor imaging unit 140, etc.). For example, the computing device 150 and operator can be located in a secured room sequestered from the location where the scanning of objects takes place to alleviate privacy concerns. The computing device 150 can also be located entirely off-site in a remote facility.

In an example embodiment, one or more portions of the communications network 505 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a Wi-Fi network, a WiMAX network, an Internet-of-Things (IoT) network established using BlueTooth® or any other protocol, any other type of network, or a combination of two or more such networks.

The system 10 shown in FIG. 1 provides scanning capabilities as described herein. However, the scanning relies on correct placement of the individual within the system 10. Although the instructional markings 13, 113 may aid the individual in understanding where to position the individual's feet, the system 10 does provide other indicators for how the individual should be positioned within the system 10 to facilitate accurate scanning.

As described below and illustrated with reference to FIGS. 3-14, the embodiments illustrated and described with reference to FIG. 1 are also equipped with an optical detection system and display to correct or guide an orientation or a pose or both of an object in any of the systems described herein. The embodiments described herein address the shortcomings of the prior art by providing an optical imaging system for providing real-time feedback to the individual for accurately positioning the individual with a scanning system. For example, FIG. 3 depicts a block diagram of a system 600 for performing a scan of an object responsive to determining that a pose of the object satisfies a target pose. The target pose is a predefined pose for object to be scanned. It should be appreciated that one or more target poses are possible. For example, in some situations, two or more target poses may be defined. In the example of FIG. 3, the system 600 includes an optical imaging device 602 to capture an image(s) of an object to be scanned. The system 600 also includes a non-optical scanning device 604 to scan the body of the object. The non-optical scanning device 604 can be one or more of the system 10, the scanner 700, and/or the like including combinations and/or multiples thereof.

According to some embodiments, the non-optical scanning device 604 is a body imager, such as a millimeter wave scanning system (or “mmwave imager”). The system 600 also includes a processing system 606 (e.g., the computing device 150). The processing system 606 can receive information from the optical imaging system 602 about the pose of an object. The information can be images or information about the images. For example, the information can be images of an individual or information about the location of a joint of an individual. The processing system 606 can also cause the non-optical scanning device 604 to initiate a scan of the body of the object responsive to determining that the pose of the object satisfies a target pose. For example, once the object achieves a suitable pose, the non-optical scanning device 604 performs a scan of the object. As used herein, pose refers to the position or orientation or both of the object to be scanned. In embodiments where the object is a human, the term “pose” as used herein can be the arrangement of the human in term of where arms/legs are, etc. The embodiments described herein refer to scanning an individual; however, the embodiments are not so limited and apply to scanning other types of objects as well. Particularly, the embodiments described herein may be used to scan any suitable object, individual, and/or the like including combinations and/or multiples thereof. The optical imaging device 602, the non-optical scanning device 604, and the processing system 606 can be in direct and/or indirect communication, such as via the communications network 505.

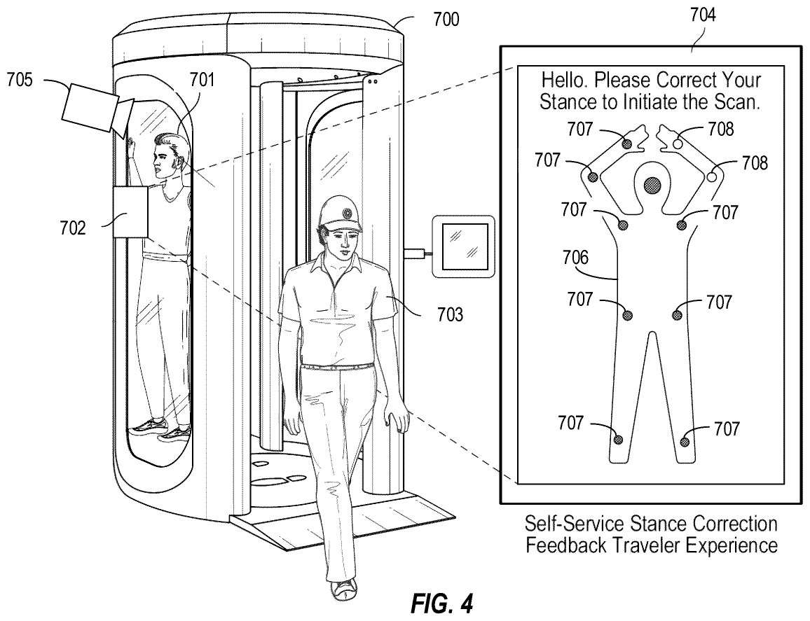

Turning now to FIG. 4, an automated process of scanning an individual is shown according to one or more embodiments described herein. Although FIG. 4 is described as scanning an individual, it should be appreciated that the automated process of FIG. 4 can be applied to scanning any suitable object. An individual 701 enters a scanner 700 (e.g., a non-optical scanning device, such as a millimeter wave scanning system). According to an embodiment, the scanner 700 is an embodiment of system 10 and includes all of the elements described above with reference to the system 10. An optical imaging system 705 within or otherwise associated with the scanner 700 determines a pose (e.g., a position and orientation) of the individual 701 and provides instructions to the individual 701 on how to achieve a desired pose. In some embodiments, the instructions to the individual 701 are provided in real-time on how to achieve a desired pose. The optical imaging system 705 includes one or more cameras to capture image(s) of the individual 701, which can be analyzed to determine a pose of the individual 701. The optical imaging system 705 can provide instructions displayed on a visual display device (e.g., the visual display device 414), such as by a monitor 702, which is enlarged as 704, or projector. The monitor 702 is an example of the visual display device 414; it should be appreciated that the monitor 702 can be any suitable visual display device, such as a monitor or projector. The instructions provide real-time feedback to the individual 701 regarding the pose of the individual 701 relative to a target pose 706. For example, the pose 706 can be made up of a plurality of points (e.g., the points 707, 708). In the example of FIG. 4, the instructions indicate that the pose of the individual 701 satisfies the target pose 706 at points 707 but indicates that the pose of the individual 701 does not satisfy the target pose 706 at points 708. The instructions may provide visual indicators to provide guidance to the individual on how to achieve the target pose 706. In some examples, the instructions may be additional to and/or other than the visual indicators, such as sound instructions (e.g., a voice command), haptic feedback (e.g., vibrations on a certain point of the scanner 700), and/or the like including combinations and/or multiples thereof. Once the individual 701 achieves the target pose 706, the scanner 700 initiates a non-optical scan of the individual 701 as described herein. This process can be performed without intervention from any supervising or managing authority (e.g., an operator 703) because the individual 701 receives positioning instructions from the optical imaging system 700. This decreases the amount of time to perform a scan because the individual 701 is receiving real-time feedback on how to achieve the target pose 706. This also improves the quality of the scan performed by the scanner 700 because the individual 701 is correctly positioned relative to the scanner 700.

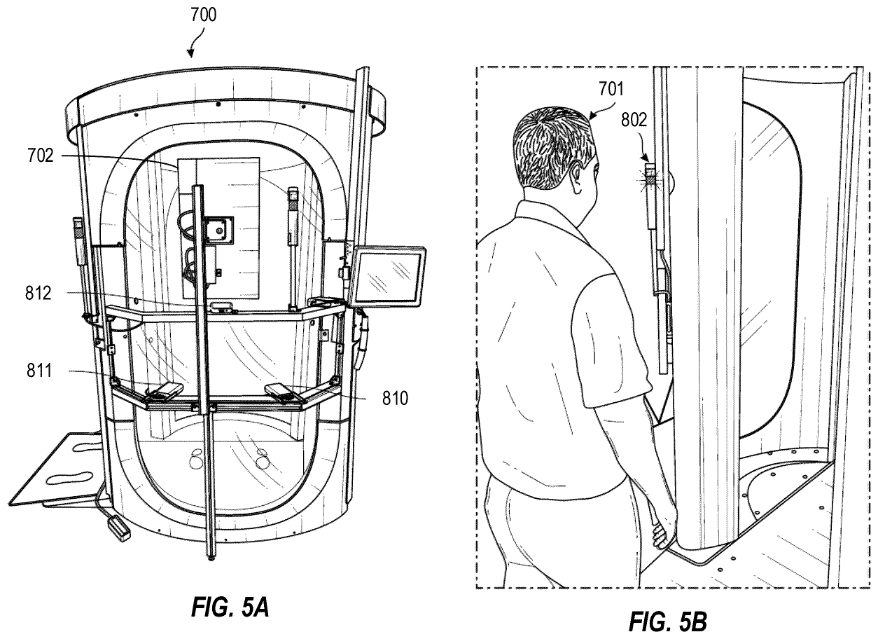

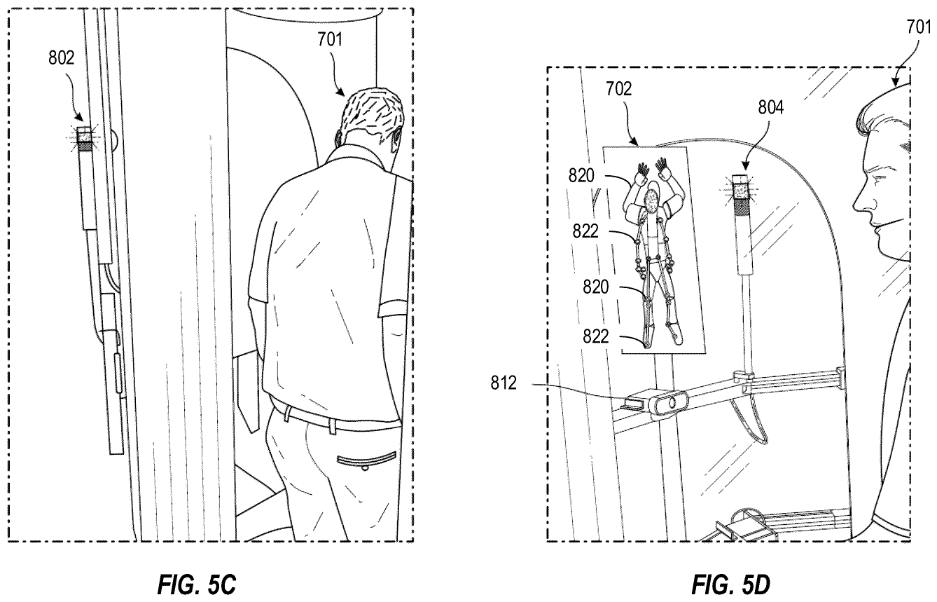

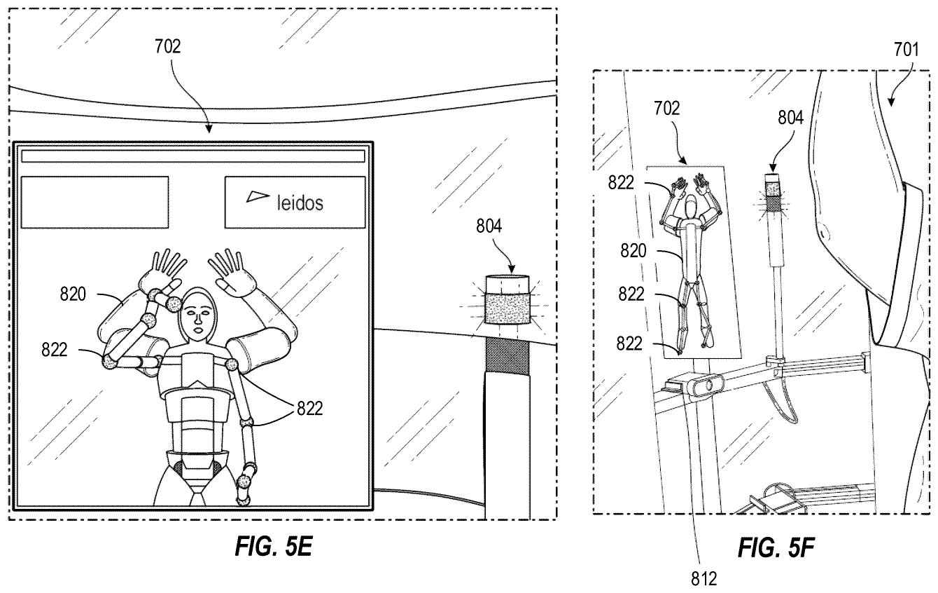

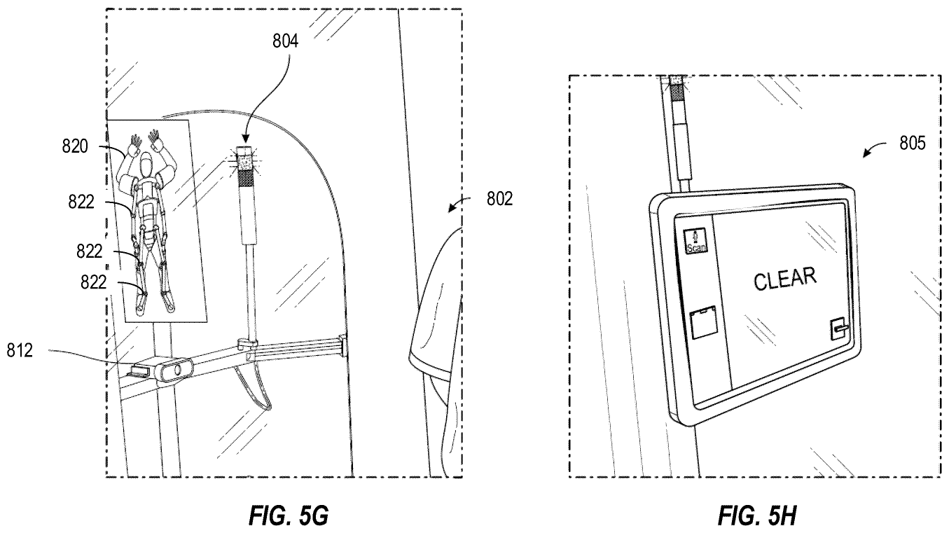

FIGS. 5A-5H illustrate an example operation of the automated process of FIG. 4 according to one or more embodiments described herein. It should be appreciated that the process shown in FIGS. 5A-5H can be self-service such that an individual 701 to be scanned can proceed through the scanning process unassisted. In some cases, an operator can assist the individual 701. As described below, in some embodiments feedback is provided to the individual to correct his or her pose or correct a detected anomaly or both. As such, the systems taught herein minimize the need for human intervention to scan an object and allow the object to enter a secure area. Specifically, FIG. 5A illustrates the scanner 700, and FIG. 5B shows the individual 701 waiting outside the scanner 700. An entrance signal light 802 may be located in proximity to an entrance of the scanner 700 to indicate a status of the scanner 700. That is, the entrance signal light 802 may selectively illuminate. For example, the entrance signal light 802 can indicate when the scanner 700 is ready for a next scan. Subsequently, the individual 701 can enter the scanner 700. For example, in FIG. 5B, when the entrance signal light 802 turns green, indicating that the scanner 700 is ready for the next scan, the individual 701 can enter the scanner 700. Once the individual 701 is inside the scanner 700, the entrance signal light 802 turns red, indicating that the scanner 700 is not available for a next individual, as shown in FIG. 5C. When the individual 701 is inside the scanner 700, a monitor 702 or another suitable device can provide to the individual 701 a feedback of a pose of the individual 701 (also referred to as “pose feedback”), as shown in FIG. 5D. According to an embodiment, the monitor 702 can be located outside the scanner 700, facing inwards towards the scanner 700 and visible by the individual 701 through a transparent radome of the scanner 700. According to some embodiments, the monitor 702 can be located in an interior portion of the scanner 700 and directly visible by the individual 701. The feedback is generated using image(s) captured by one or more cameras 810, 811, 812, which can be positioned to capture the image(s) of at least a portion of the individual 701 located within the scanner 700. The feedback can instruct the individual 701 how to pose (e.g., where the body joints of the individual 701 need to be), as shown in FIG. 5E. For example, an avatar 820 can be used to provide feedback. The avatar 820 is a representation of the object to be scanned. For example, if the object to be scanned is an individual, the avatar can be a human form. The avatar 820 acts as the target pose for the object. Points 822 corresponding to the object to be scanned (e.g., joints of an individual) can be overlaid on the avatar, as shown in FIGS. 5D-5G. The points 822 together form a real-time representation of the object to be scanned. That is, the points 822 collectively represent the object in real-time. In order to satisfy the target pose, the points 822 of the object should be positioned to align with corresponding points on the avatar 800. In an example, each joint can either be red, indicating that the respective joint is incorrectly positioned, or be green, indicating that the respective joint is correctly positioned. Once the user achieves the target pose (e.g., the feedback indicates all joints are green, as shown in FIG. 5F), a HOLD instruction can be displayed on the monitor 702 to indicate to the individual 702 to maintain the pose. A scan signal light 804, which can be located outside the scanner 700 and/or in an interior portion of the scanner 700, can turn green, and a scan of the individual 701 can be initiated. Once the scan is completed, an instruction can be displayed on the monitor 702 indicating to the individual 701 that the scan has been completed. Then, the scan signal light 804 can turn red, and the individual 701 can exit the scanner 700, as shown in FIG. 5G. After the individual 701 exits the scanner 700, an operator outside the scanner 700 can view a result of the scan on an operator display 805, and the entrance signal light 802 can turn green so that the next individual can enter the scanner 700 to restart the automated process.

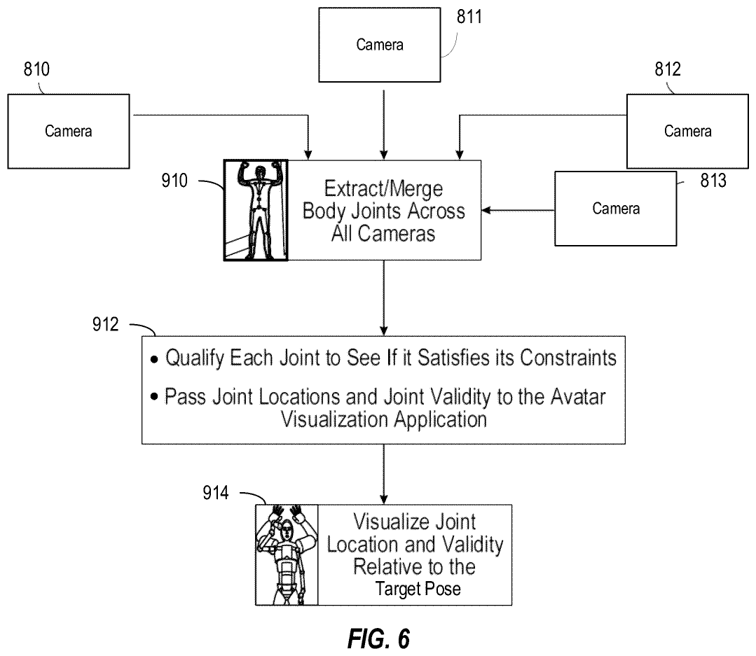

FIG. 6 shows a data flow of generating pose feedback according to one or more embodiments described herein. In the example of FIG. 6, multiple cameras 810-813 are used to capture images of an object, such as an individual, prior to performing a non-optical scan of the object. It should be appreciated that other numbers of cameras can be used, such as one camera, two cameras, three cameras, or more than four cameras. Each camera 810-813 can be one of the cameras 810-812 positioned near or within a scanner (e.g., the system 10, the scanner 700, and/or the like including combinations and/or multiples thereof) and can capture images of an object (e.g., the individual 701) within a field of view (FOV) of the respective camera 810-813.

At block 910, a computing device (e.g., the computing device 150) can analyze images captured by the cameras 810-813. For example, the computing device can determine a pose of the object. According to an embodiment where the object is an individual, the computing device can determine body joint information of the individual, including body locations, and metadata, can be extracted from the body images of the human. For example, the metadata can indicate types of joints (e.g., elbow, wrist, shoulder, knee, ankle, hip, and/or the like including combinations and/or multiples thereof) of the individual or other characteristics of the object being scanned. The metadata is useful, for example, for reconstructing an image of the object where the cameras 810-813 captured portions of the object. Known location information for the cameras can also be used for reconstructing the images. As an example, the body joints can be merged based on the camera locations and the metadata. At block 912, the merged body joints can be qualified based on a predefined pose, a desired pose, or a function of the location data, and then are handed off to a visualization software (e.g., an avatar visualization application) at block 914. The visualization software provides to visualize the body joints relative to the predefined pose or the desired pose. More particularly, the joint locations are visualized, such as on the monitor 702, relative to the target pose (e.g., an ideal pose represented as an avatar in some embodiments). For example, an avatar or another suitable representation of the target pose can be displayed on the monitor 702 that also depicts the pose of the user. With reference to FIGS. 5D-5F, the avatar 820 is displayed on the monitor 702 to represent the target pose, and the pose of the user is overlaid on the avatar 820 as points 822. This enables the target pose to be displayed concurrently with the pose of the individual (e.g., the pose of the individual can be overlaid on the target pose). The individual can then visualize how the individual needs to move to satisfy the target pose by viewing the avatar 820 on the monitor 702.

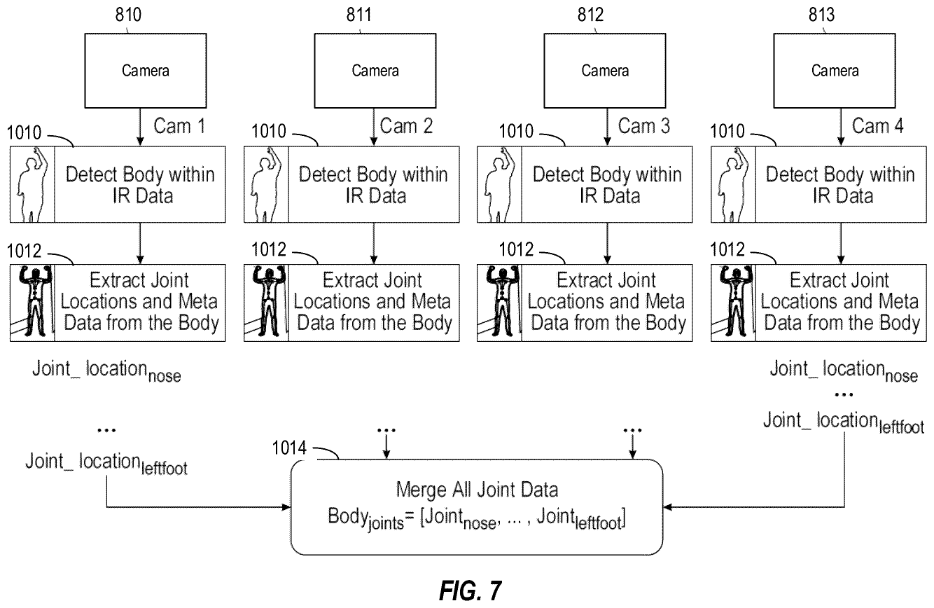

FIG. 7 illustrates a body joint estimation and merging method according to one or more embodiments described herein. In the example of FIG. 7, multiple cameras 810-813 are used to capture images of an object prior to performing a non-optical scan of the object. Each camera 810-813 can be positioned near or within a scanner (e.g., the system 10, the system 90, the scanner 700 and/or the like including combinations and/or multiples thereof) and can capture images of an object (e.g., the individual 701) within a field of view (FOV) of the respective camera 810-813.

In an example, the cameras 810-813 can be visible, depth-sensing, and/or infrared (IR) cameras. According to one or more embodiments described herein, one or more of the cameras 810-813 can directly estimate the pose. At blocks 1010, data from the cameras 810-813 are received and processed to detect a body of an individual (or an object) using, for example, the IR data from IR cameras. At blocks 1012, joint locations and metadata are extracted for the body of the individual. Body joint locations and the metadata can be extracted from, for instance, the IR data detected by the IR camera. At block 1014, the body joints from the blocks 1012 can be merged using, for example, the camera locations and the metadata. According to one or more embodiments described herein, map depth can be used to perform real-time pose or skeletal recognition. According to one or more embodiments described herein, the processing system 606 (e.g., the computing system 150) and/or the camera (e.g., the optical imaging device 602) includes one or models, and the processing system 606 maps the image data to the model to determine pose or orientation.

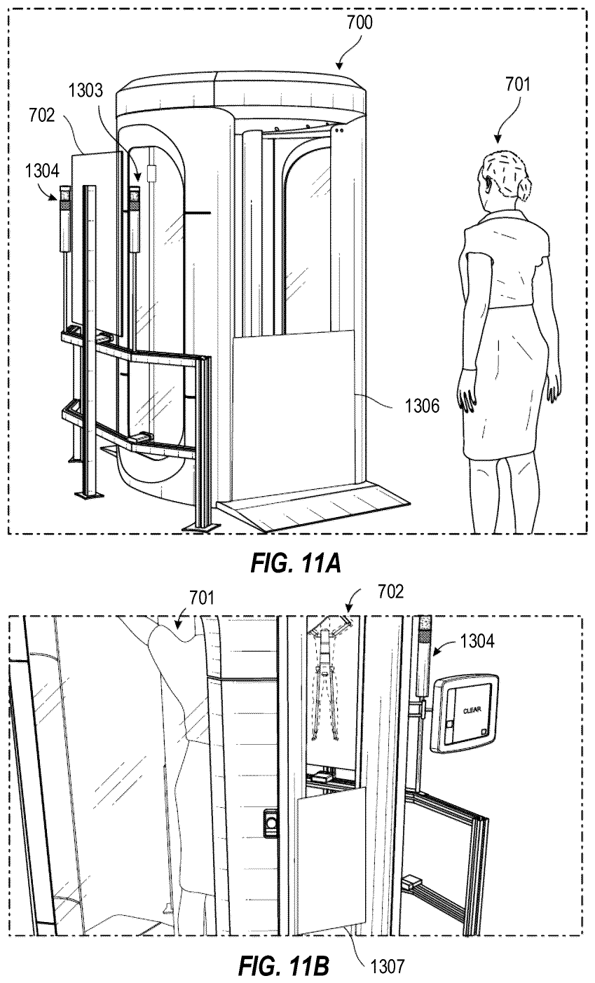

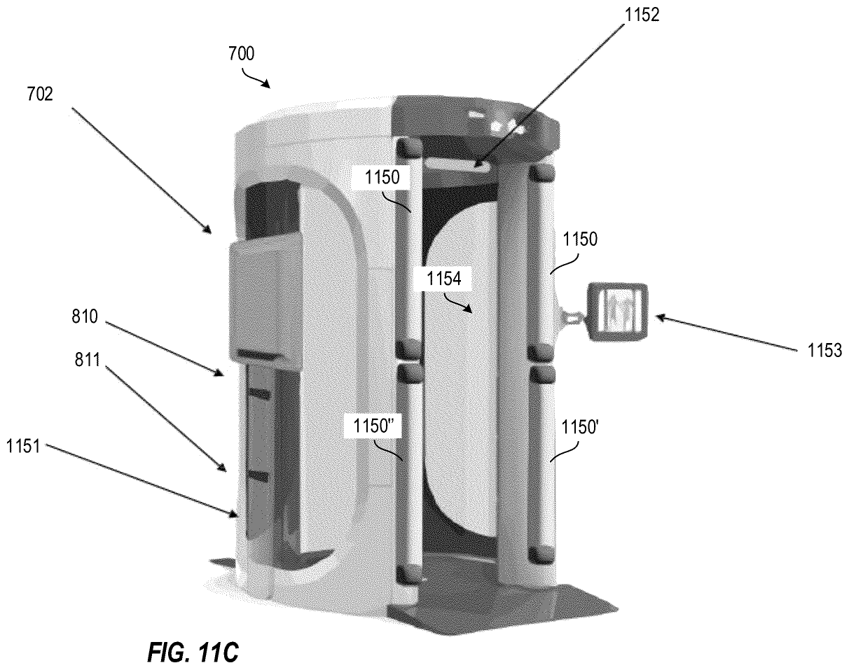

FIG. 11A illustrates an example of a scanning system 1100 used to control a scanning device (e.g., the system 10, the scanner 700, and/or the like including combinations and/or multiples thereof) according to an embodiment of the disclosure. As shown in FIG. 11, the scanning system 1100 includes the camera 810, which is a camera 810(e.g., the optical imaging device 602), a processing device 1102, a scanning device 1103 (e.g., the non-optical scanning device 604), a volatile memory 1104, and a non-volatile memory 1105. The camera 810 can take images of an object. The scanning system 1100 uses data acquired by the camera 810 (or multiple cameras/imaging devices) to determine whether an object is posed or oriented correctly relative to a target pose or orientation. The scanning system 1100 then causes the scanning device 1103 to initiate a scan of the object when it is determined whether the object is posed or oriented correctly relative to a target pose or orientation. The scanning device 1103 can perform a scan of the object.

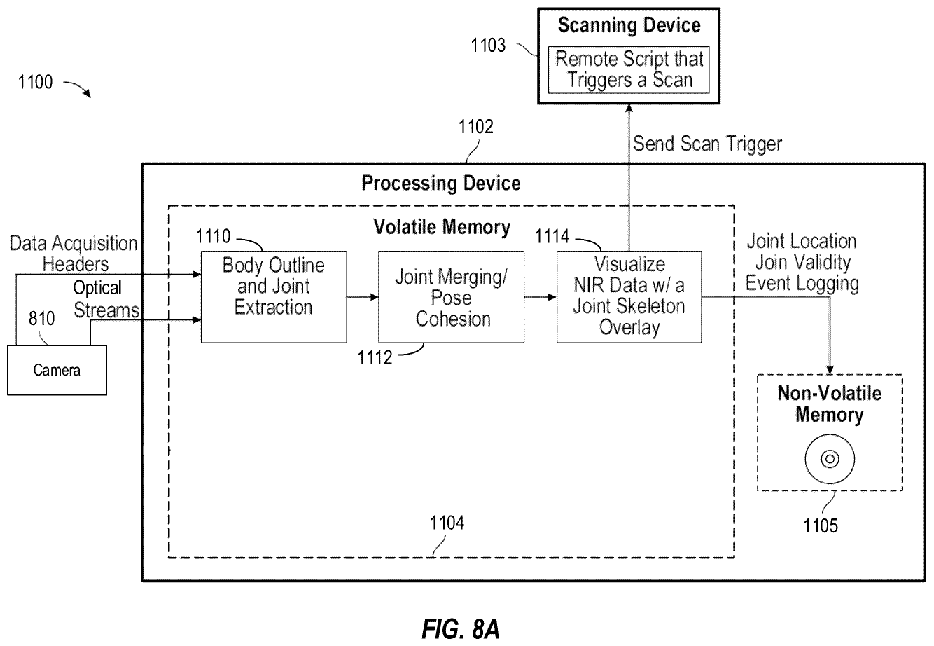

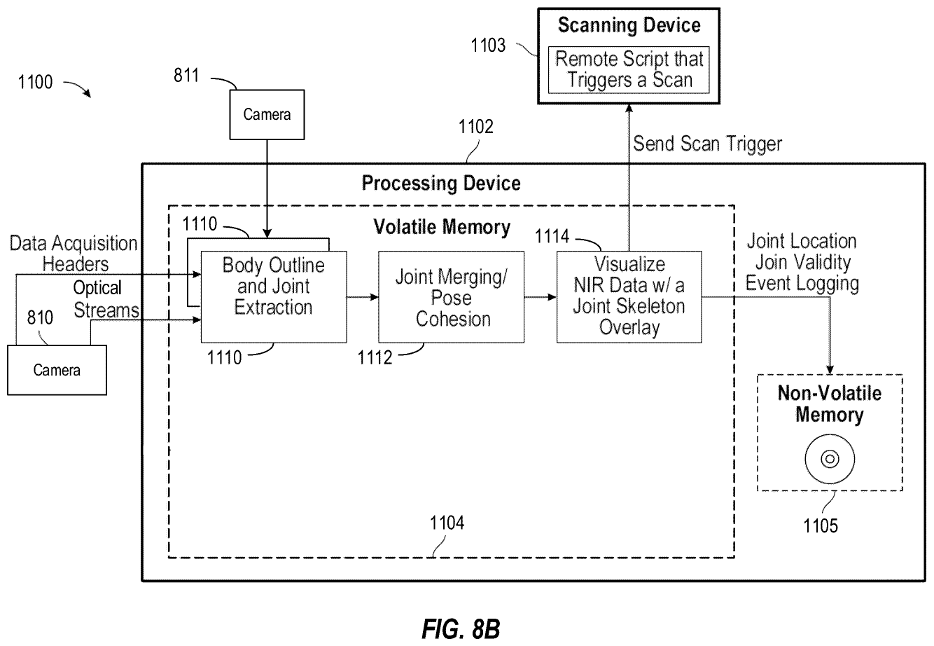

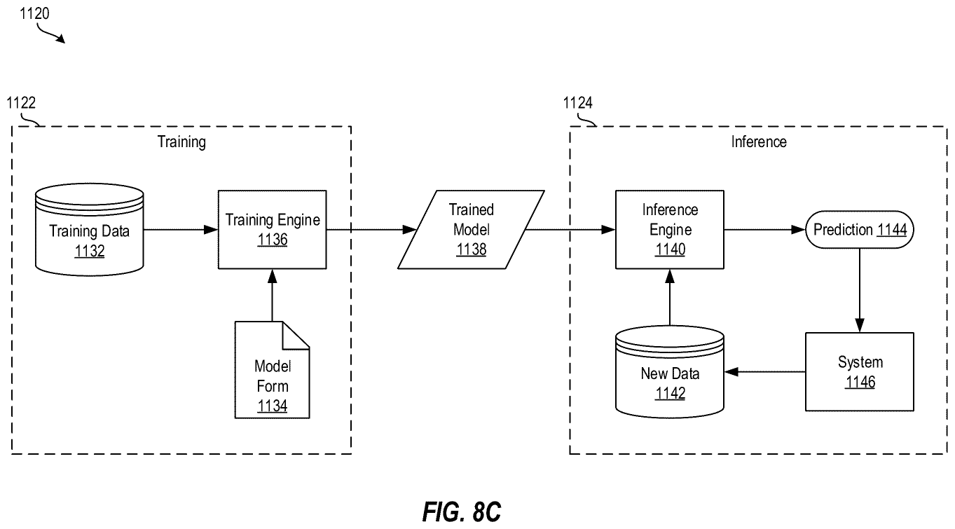

The scanning system 1100 can include a single camera 810 in some embodiments as shown in FIG. 8A or can include multiple cameras 810, 811 as shown in FIG. 8B. It should be appreciated that the scanning system 1100 can include more than two imaging devices in other embodiments. Technical benefits of using multiple cameras instead of single camera include redundancy, more robust joint estimates, and/or a wider field of view. As an example, the wider field of view can provide for capturing images of the object as the object is entering the scanner. In an example, one or more of the cameras 810, 811 can be a device that includes a depth sensor, a video camera, and an orientation sensor. One or more of the cameras 810, 811 can be a visible light imaging, an IR imaging device that takes IR images, or a depth-sensing camera. The processing device 1102 can read in a near infrared (NIR) data stream, a visible camera data stream, and/or data acquisition headers from one or more of the cameras 810, 812 simultaneously into a volatile memory 1104 of the processing device 1102. The volatile memory 1104 can include non-transitory computer readable instructions that, when executed by the processing device 1102, perform operations as shown in blocks 1110, 1112, 1114, for example.

With reference to FIG. 8A, the block 1110 receives data acquisition headers and optical streams from the camera 810. The block 1110 uses the data acquisition headers and the optical streams to determine an outline for the object to be scanned. In the case of an individual, the block 1110 identifies and extracts joint information for body joints (e.g., elbows, knees, etc.) of the individual. In the case of an object, the block 1110 identifies and extracts features of the object (e.g., corners, edges, etc.). With reference to FIG. 8B, the volatile memory 1104 may have multiple instances of the block 1110 where multiple cameras 810, 811 are used (e.g., one instance of block 1110 for each camera 810, 811). According to one or more embodiments described herein, the cameras 810, 811 can perform pre-processing on the acquired image data before transmitting the data acquisition headers and optical streams to block 1110. For example, the camera 810 can directly perform estimation for a pose of an object to be scanned. The block 1110 can include publically available software development kits (SDKs) to provide outline and joint/feature extraction functionality.

With reference to FIGS. 8A and 8B, the block 1112 receives the extracted outline and joint/feature information from the block 1110 and merges the joints/features to determine a pose of the object captured by the camera 810 (and the camera 811 in FIG. 11B). According to an embodiment, the block 1110 determines three-dimensional (3D) coordinates of a plurality of (e.g., 32) joint locations of an individual and determines corresponding Boolean values for each joint location. These values can be used to compare the current pose of the individual with a target pose in order to specify whether a corresponding joint fits the target pose. These values can be saved into the non-volatile memory 505 of the processing device 502.

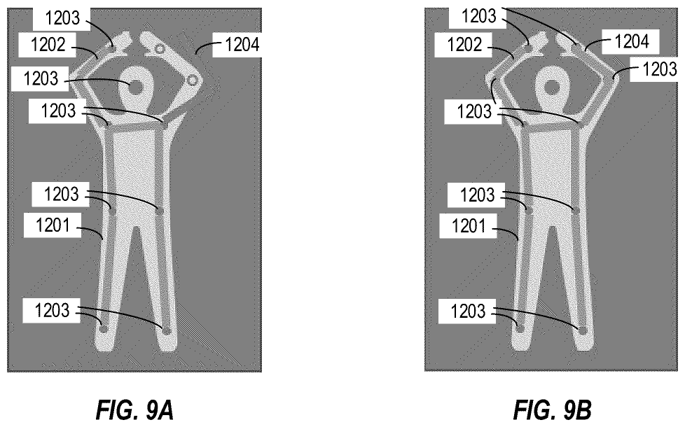

At block 1114, the scanning system 1100 generates a visualization of the joints of the individual (or features of the object) overlaid on a representation of the target pose, for example, the avatar. For example, the visualization can include a visual representation of the object using data collected by the camera 810 and/or the camera 810 overlaid with a target pose (see, e.g., FIG. 4). According to one or more embodiments described herein, a skeletal representation of the individual can be generated using the joint information from blocks 1110, 1112 and overlaid with a visual representation of the target pose or overlaid on the visual representation (i.e., an avatar) of the target pose. For example, FIGS. 9A and 9B depict skeletal representations 1202 of an individual overlaid with a visual representation 1201 (e.g., the avatar 802) of the target pose. In FIG. 9A, the portion 1203 of the skeletal representation 1202 is shown to not satisfy the target pose. Particular, the right arm of the individual is posed to satisfy the target pose. Conversely, in FIG. 9B, the portion 1203 of the skeletal representation 1202 is shown as satisfying the target pose. According to one or more embodiments described herein, colorization of the pose segments can be used to guide the individual into the proper pose. For example, a first color (e.g., green) can be used to indicate a correct pose of an object, and a second color (e.g., red) can be used to indicate an incorrect pose of the object. Different colors can be used in other embodiments.

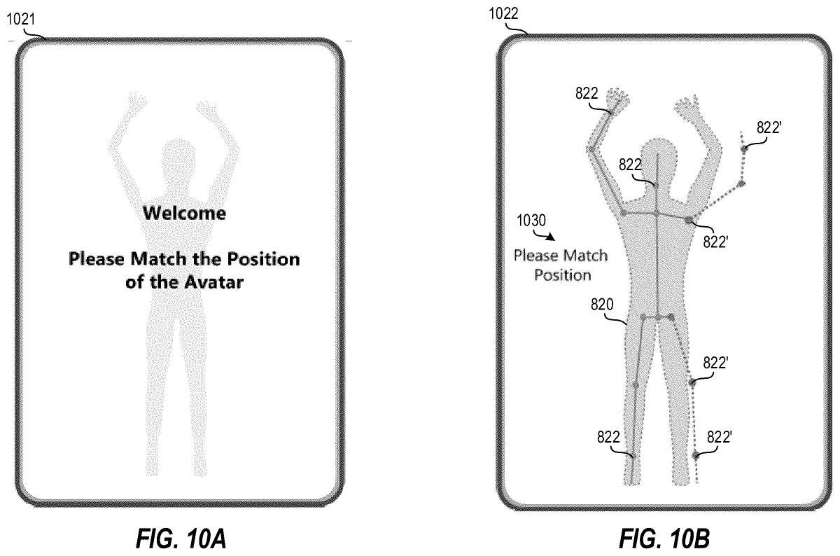

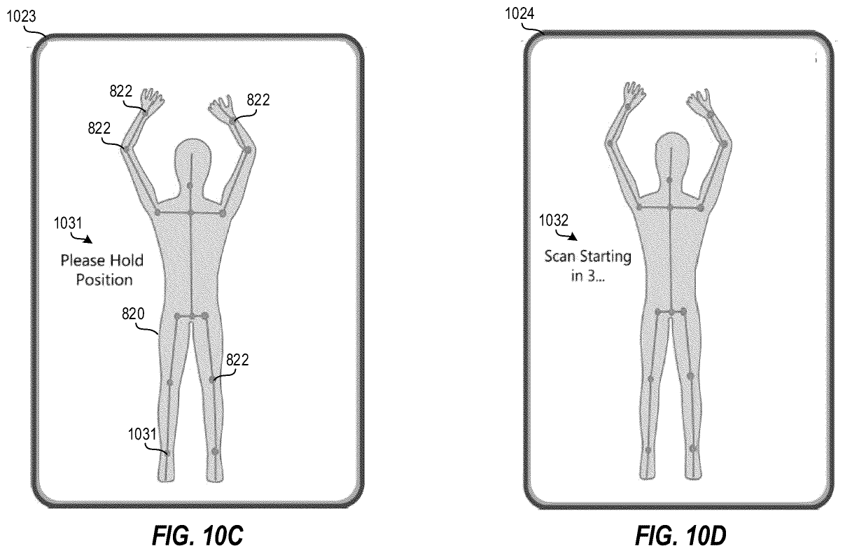

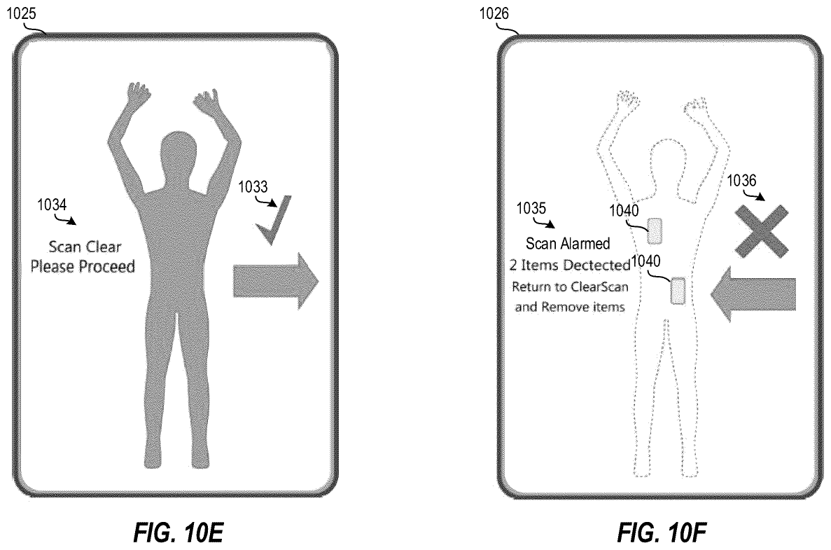

Other visualizations are also possible. For example, FIGS. 10A-10F illustrate interfaces 1021-1026 according to one or more embodiments described herein. The interfaces can be displayed by a visual display device, such as a monitor or projector. The interfaces 1021-1026 are now described with reference to scanning an individual but are not so limited. The interface 1021 (FIG. 10A) is an initial or “welcome” interface presented when the individual enters the scanner (e.g., the imaging chamber 11). After the occurrence of an event, such as the expiration of a timer or interrupting an optical or electromagnetic detector, the interface 1022 is presented. The interface 1022 (FIG. 10B) provides readable instructions 1030 (e.g., “Please Match Position”) instructing the individual regarding the individual's pose (shown by points 822) relative to a target pose represented as the avatar 820. In this example, the solid lines of the individual's pose connecting points 822 represent proper alignment, and the dashed lines of the individual's pose 1031 connecting points 822′ represent improper alignment. Different indicators can be used to show proper and improper alignments, such as different colors, different line thicknesses or styles, and/or the like including combinations and/or multiples thereof. For example, the proper alignment lines can be green solid lines and the improper alignment lines can be red dashed lines. Further, the dashed line outlining the avatar 820 indicates that the individual's pose is not properly aligned. The individual can then make adjustments to achieve proper alignment. Once the individual is properly aligned, as shown on the interface 1023 (FIG. 10C), each of the lines connecting points 822 of the individual's pose and the avatar 802 are changed to indicate proper alignment. For example, the lines can be solid green lines. The interface 1023 provides readable instructions 1031 to the individual (e.g., “Please Hold Position”). The interface 1024 (FIG. 10D) provides notice that the scan is about to begin, and a countdown can be displayed, for example, via the readable instructions 1032 (e.g., Scan Starting in 3 . . . ”). The interfaces 1025, 1026 depict results of the scan. For example, the interface 1025 (FIG. 10E) represents a scan with no alarmed region. The results of the scan can be shown in various ways, such as by turning the avatar 802 a certain color (e.g., green), by filling in the avatar 802, by providing a “passed” indicator 1033 (e.g., a checkmark and/or an arrow), by providing instructions 1034 (e.g., “Scan Clear Please Proceed”), and/or the like including combinations and/or multiples thereof. In the case that the passed indicator 1033 is an arrow, the arrow can point in a direction the individual is instructed to move. In contrast to the interface 1025, the interface 1026 (FIG. 10F) represents a scan with an alarmed region 1040. In the example of FIG. 10F, two alarmed regions 1040 are shown, but any number of alarmed regions are possible. The interface 1026 can indicate to the individual that the individual did not pass the scan. For example, if the individual did not pass the scan because items are detected, the avatar 802 can turn a first color (e.g., white) with a second color (e.g., red) dashed border. The avatar 802 can indicate the alarmed region 1040 where the anomaly, for example, an item(s) was detected. The interface 1026 can present instructions 1035 that indicate that the scan alarmed, how many items were detected, and instructions to remove the items. This gives the individual a chance to resolve issues that caused the alarmed regions (e.g., to remove an item from a pocket). Thus, issues may be resolved independently by the user without assistance from an operator. Other indicators can also be provided, such as “failed” indicator 1036 (e.g., an “X” and/or an arrow). In the case that the failed indicator 1036 is an arrow, the arrow can point in a direction the individual is instructed to move. The failed indicator 1036 may be shown, for example, after a particular number (e.g., 3) of failed scan attempts. This provides the individual with opportunities to resolve issues independently without assistance from an operator. In some embodiments, in addition to the readable instructions, automated verbal instructions and feedback can be provided to the individual regarding how to pose, how to correct a pose, to remain still and so on.

With continued reference to FIGS. 8A and 8B, the processing device 1102 can determine whether the pose of the individual (or object) satisfies the target pose. If the pose of the individual (or object) is determined to satisfy the target pose (e.g., FIG. 9B), the processing device 1102 can send a scan trigger command to the scanning device 1103. The scanning device 1103 can execute a remote script (remote being relative to the processing device 1102) to initiate the scan (e.g., millimeter wave scanning) of the object. If the pose of the object is determined not to satisfy the target pose (e.g., FIG. 9A), the visual representation can be used to instruct the individual to reposition until the target pose is achieved. According to one or more embodiments described herein, a timeout period can be set to give the individual a certain amount of time (e.g., 30 seconds, 1 minute, 5 minutes, and/or the like including combinations and/or multiples thereof) to satisfy the target pose.

As an example, the scanning system 1100 can use four cameras 810-813 (see FIGS. 6 and 7) to extract four separate joint and body outline data streams (block 1110). The scanning system 1100 can then merge the four separate joint and body outline data streams (block 1112) and can display a visualization of skeletal representation overlaid on a target pose (e.g., body outline) (block 1114).

The processing device 1102 can store data, such as joint location data, joint validity data, and event logging data, in the non-volatile memory 1105 for later use.

According to one or more embodiments described herein, the processing device 1102 can execute an automated algorithm (e.g., a machine learning algorithm or an artificial intelligence algorithm) for determining the pose of the object using data received from the cameras 810, 811. One or more embodiments described herein can utilize machine learning techniques to perform tasks, such as determining the pose of the object. More specifically, one or more embodiments described herein can incorporate and utilize rule-based decision making and artificial intelligence (AI) reasoning to accomplish the various operations described herein, namely determining the pose of the individual or position or orientation of the object. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for determining the pose of the object, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of determining the pose of the object as described herein.

In some embodiments, the machine learning algorithm can include, for example, supervised learning algorithms, unsupervised learning algorithm, artificial neural network algorithms, association rule learning algorithms, hierarchical clustering algorithms, cluster analysis algorithms, outlier detection algorithms, semi-supervised learning algorithms, reinforcement learning algorithms and/or deep learning algorithms Examples of supervised learning algorithms can include, for example, AODE; Artificial neural network, such as Backpropagation, Autoencoders, Hopfield networks, Boltzmann machines, Restricted Boltzmann Machines, and/or Spiking neural networks; Bayesian statistics, such as Bayesian network and/or Bayesian knowledge base; Case-based reasoning; Gaussian process regression; Gene expression programming; Group method of data handling (GMDH); Inductive logic programming; Instance-based learning; Lazy learning; Learning Automata; Learning Vector Quantization; Logistic Model Tree; Minimum message length (decision trees, decision graphs, etc.), such as Nearest Neighbor algorithms and/or Analogical modeling; Probably approximately correct learning (PAC) learning; Ripple down rules, a knowledge acquisition methodology; Symbolic machine learning algorithms; Support vector machines; Random Forests; Ensembles of classifiers, such as Bootstrap aggregating (bagging) and/or Boosting (meta-algorithm); Ordinal classification; Information fuzzy networks (IFN); Conditional Random Field; ANOVA; Linear classifiers, such as Fisher's linear discriminant, Linear regression, Logistic regression, Multinomial logistic regression, Naive Bayes classifier, Perceptron, and/or Support vector machines; Quadratic classifiers; k-nearest neighbor; Boosting; Decision trees, such as C4.5, Random forests, ID3, CART, SLIQ, and/or SPRINT; Bayesian networks, such as Naive Bayes; and/or Hidden Markov models. Examples of unsupervised learning algorithms can include Expectation-maximization algorithm; Vector Quantization; Generative topographic map; and/or Information bottleneck method. Examples of artificial neural network can include Self-organizing maps. Examples of association rule learning algorithms can include Apriori algorithm; Eclat algorithm; and/or FP-growth algorithm. Examples of hierarchical clustering can include Single-linkage clustering and/or Conceptual clustering. Examples of cluster analysis can include K-means algorithm; Fuzzy clustering; DBSCAN; and/or OPTICS algorithm. Examples of outlier detection can include Local Outlier Factors. Examples of semi-supervised learning algorithms can include Generative models; Low-density separation; Graph-based methods; and/or Co-training. Examples of reinforcement learning algorithms can include Temporal difference learning; Q-learning; Learning Automata; and/or SARSA. Examples of deep learning algorithms can include Deep belief networks; Deep Boltzmann machines; Deep Convolutional neural networks; Deep Recurrent neural networks; and/or Hierarchical temporal memory.

Systems for training and using a machine learning model are now described in more detail with reference to FIG. 8C. Particularly, FIG. 8C depicts a block diagram of components of a machine learning training and inference system 1120 according to one or more embodiments described herein. The system 1120 performs training 1122 and inference 1124. During training 1122, a training engine 1136 trains a model (e.g., the trained model 1138) to perform a task, such as to determine the pose of the object. Inference 1124 is the process of implementing the trained model 1138 to perform the task, such as to determine the pose of the object, in the context of a larger system (e.g., a system 1146). All or a portion of the system 1120 shown in FIG. 8C can be implemented, for example by all or a subset of computing device 150 or another suitable system or device.

The training 1122 begins with training data 1132, which may be structured or unstructured data. According to one or more embodiments described herein, the training data 1132 includes examples of poses of the object. For example, the information can include visible images of individuals in different poses along with joint information about the individuals, NMR information of individuals in different poses along with joint information about the individuals, and/or the like including combinations and/or multiples thereof. The training engine 1136 receives the training data 1132 and a model form 1134. The model form 1134 represents a base model that is untrained. The model form 1134 can have preset weights and biases, which can be adjusted during training. It should be appreciated that the model form 1134 can be selected from many different model forms depending on the task to be performed. For example, where the training 1122 is to train a model to perform image classification, the model form 1134 may be a model form of a CNN. The training 1122 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 1132 includes labeled images, including images of the object of interest with associated labels (ground truth) and other images that do not include the object of interest with associated labels. In this example, the training engine 1136 takes as input a training image from the training data 1132, makes a prediction for classifying the image, and compares the prediction to the known label. The training engine 1136 then adjusts weights and/or biases of the model based on results of the comparison, such as by using backpropagation. The training 1122 may be performed multiple times (referred to as “epochs”) until a suitable model is trained (e.g., the trained model 1138).

Once trained, the trained model 1138 can be used to perform inference 1124 to perform a task, such as to determine the pose of the object. The inference engine 1140 applies the trained model 1138 to new data 1142 (e.g., real-world, non-training data). For example, if the trained model 1138 is trained to classify images of a particular object, such as a chair, the new data 1142 can be an image of a chair that was not part of the training data 1132. In this way, the new data 1142 represents data to which the model 1138 has not been exposed. The inference engine 1140 makes a prediction 1144 (e.g., a classification of an object in an image of the new data 1142) and passes the prediction 1144 to the system 1146 (e.g., the computing device 150). According to one or more embodiments described herein, the prediction can include a probability or confidence score associated with the prediction (e.g., how confident the inference engine 1140 is in the prediction). The system 1146 can, based on the prediction 1144, taken an action, perform an operation, perform an analysis, and/or the like, including combinations and/or multiples thereof. In some embodiments, the system 1146 can add to and/or modify the new data 1142 based on the prediction 1144.

In accordance with one or more embodiments, the predictions 1144 generated by the inference engine 1140 are periodically monitored and verified to ensure that the inference engine 1140 is operating as expected. Based on the verification, additional training 1122 may occur using the trained model 1138 as the starting point. The additional training 1122 may include all or a subset of the original training data 1132 and/or new training data 1132. In accordance with one or more embodiments, the training 1122 includes updating the trained model 1138 to account for changes in expected input data.

With continued reference to FIGS. 8A and 8B, the processing device 1102 can provide traffic flow direction of objects using a traffic flow gate(s) and/or a traffic flow light(s), such as to control movement of an individual into and out of a scanner (e.g., the system 10, the scanner 700, and/or the like including combinations and/or multiples thereof). For example, FIGS. 11A and 11B show a scanner 700 that uses traffic flow devices (e.g., gates, lights, and/or the like including combinations and/or multiples thereof). Particularly, the scanner 700 is configured with multiple traffic flow devices, including an entrance guide light (or indicator) 603, an exit guide light (or indicator) 604, an entrance electronic-gate (E-gate) 1306, and an exit E-gate 1307. The exit E-gate 1307 is also referred to as a “downstream traffic flow gate.”

The entrance E-gate 1306 is used for controlling the flow of objects (e.g., the individual 701) to be scanned into the scanner 700. For example, the entrance E-gate 1306 opens to permit a next object to be scanned into the scanner 700 and then closes once the object enters the scanner 700. The entrance E-gate 1306 can be used with or without the entrance guide light (or indicator) 1303. The entrance guide light 1303 can provide a visual indication to an individual. For example, the entrance guide light 1303 may be turned on while the entrance E-gate 1306 is opened or may be changed to a particular color, such as green. Conversely, the entrance guide light 1303 may be turned off while the entrance E-gate 1306 is closed or may be changed to a particular color, such as red. According to one or more embodiments described herein, the entrance guide light 1303 can flash while the entrance E-gate 1306 is opening or closing, or just before the entrance E-gate 1306 begins opening or closing. The entrance E-gate 1306 can be attached directly to the scanner 700 or used in combination with other guard rails. The entrance E-gate 1306 can be controlled by any suitable system or device, such as the computing device 150.

The exit E-gate 1307 is used for controlling the exit flow of objects to be scanned out of the scanner 700. For example, the exit E-gate 1307 opens to permit the object having been scanned to exit the scanner 700 and then closes. In some embodiments, the exit E-gate 1307 can remain closed if a rescan is to be performed or if additional screening (e.g., a Level 2 security screening) is to be performed. For example, a rescan may be performed if the scan fails. The exit E-gate 1307 can be used with or without the exit guide light (or indicator) 1304. The exit guide light 1304 can provide a visual indication to an individual. For example, the exit guide light 1304 may be turned on while the exit E-gate 1307 is opened or may be changed to a particular color, such as green. Conversely, the exit guide light 1304 may be turned off while the exit E-gate 1307 is closed or may be changed to a particular color, such as red. According to one or more embodiments described herein, the exit guide light 1304 can flash while the exit E-gate 1307 is opening or closing, or just before the exit E-gate 1307 begins opening or closing. The exit E-gate 1307 can be attached directly to the scanner 700 or used in combination with other guard rails. The exit E-gate 1307 can be controlled by any suitable system or device, such as the computing device 150. It should be appreciated that the entrance guide light 1303 and/or the exit guide light 1304 can be incorporated into the scanner 700 and/or can be stand-alone lights as shown. Further, the lights can use different indicia (e.g., colors, symbols, etc.) to provide information. According to one or more embodiments described herein, a speaker or other sound generating device can be used to supplement the information provided by the lights. For example, a sound may be generated when one or more of the entrance guide light 1303 or the exit guide light 1304 is illuminated.

In addition, the scanner 700 includes a monitor 702 that provides instructions to a person to be scanned on how to correctly position the person. For example, the monitor 702 can display the skeletal representations 1202 of an individual overlaid with a visual representation 1201 of the target pose as shown, for example, in FIGS. 9A and 9B. In this way, the monitor 702 provides instructions to the individual on how to achieve the target pose.

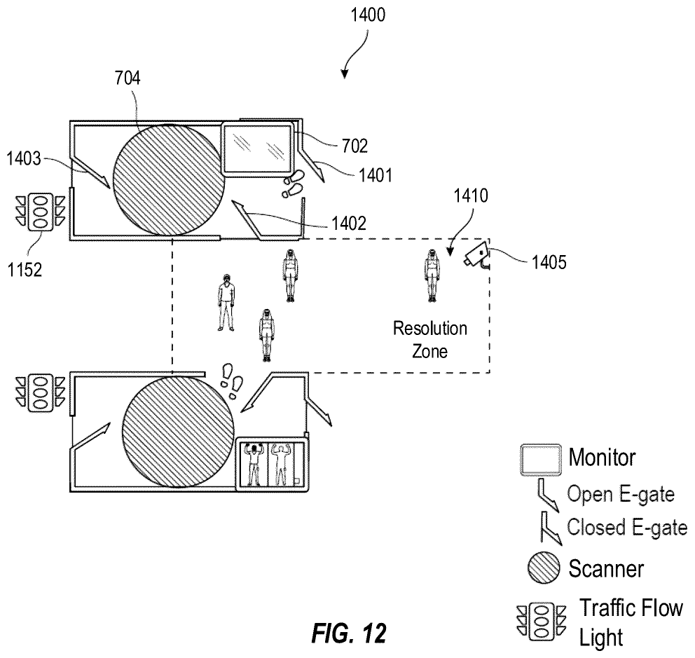

Other arrangements of traffic flow devices, such as gates and lights, are also possible, including “virtual gates” that provide an audible alarm, an audible messaging system, or a visual feedback (for instance on a monitor or projected nearby the user). For example, FIG. 11C illustrates the scanner 700 having a light curtain that provides gate functionality according to one or more embodiments described herein. In this example, the scanner 700 includes the monitor 702, the cameras 810, 811, light curtains 1150, a cable chase 1151, a passenger control light 1152, and a monitor 1153. The monitor 702 can be any suitable visual display device (e.g., monitor or projector) to provide instructions or feedback to an individual, such as regarding the individual's pose, as described herein. The cameras 810, 811 represent any suitable camera (e.g., visible light camera, IR camera, and/or the like including combinations and/or multiples thereof) as described herein. It should be appreciated that other numbers of cameras can be used in different examples. The cable chase 1151 provides a chase to house cables (and/or the cameras 810, 811). The passenger control light 1152 is used to provide guidance to the individual as described with respect to FIG. 12, for example. The passenger control light 1152 can be, for example, an addressable light-emitting diode (LED) light. The monitor 1153 can provide individuals with instructions prior to entering the scanner 700.

The light curtains 1150 can function as a virtual gate to restrict entry into or exit out of a certain area, such as the scanner 700. For example, the light curtains 1150 in FIG. 11C are positioned on each side of an entrance 1154 of the scanner 700 as shown, although other arrangements are also possible. The light curtains 1150 act to restrict entry into or exit out of the scanner 700 through the entrance 1154. The light curtains 1150 are opto-electronic devices that form an optical barrier, when activated, by generating beams of light (e.g., infrared light) from a transmitter light curtain 1150′ to a receiver transmitter light curtain 1150″. If an object passes through the area between the transmitter light curtain 1150′ and the receiver transmitter light curtain 1150″ when the light curtains 1150 are activated, the beams of light are interrupted and a signal—such as an audible alarm, message, light color change, or monitor graphic—can be generated to alert to the interruption. The light curtains 1150 are less imposing on individuals than gates (e.g., the e-gates 1306, 1306) because they are visible but not physical barriers.

As another example, FIG. 12 shows a screening station 1400 including a resolution zone (or station) 1410 according to one or more embodiments described herein. In this example, the screen station 1400 includes an entrance gate 1403, a passenger control light 1152, a scanner 704, a first exit E-gate 1401 and a second exit E-gate 1402. The passenger control light 1152 can illuminate or otherwise indicate to an individual that the individual may enter the scanner 704. Additionally, process cues (such as lights) can be used to direct the individual's motion both into the scanner 704, and the individual's subsequent motion (“traffic control”), thereby further improving automation. The entrance gate 1403 opens to permit the individual to enter the scanner 704. The individual poses to be scanned, and a computing device (e.g., the computing device 150) analyses the pose of the individual as described herein to determine whether the pose satisfies a target pose. Results of the analysis (e.g., feedback/instructions) can be displayed to the individual via a monitor 702 as described herein. Upon the completion of the scan, depending on the results of the scan, one of the first exit E-gate 1401 or the second exit E-gate 1402 opens. According to one or more embodiments described herein, pose feedback as described herein can be implemented in accordance with the screening station 1400 of FIG. 12.

The traffic-control configuration shown in FIG. 12 provides for multi-level screening. A first level of screening, referred to as Level 1 screening, refers to the screening conducted by the scanner 700. A second level of screening, referred to as Level 2 screening, refers to the screening conducted in a resolution zone 1410. Level 2 screening may be bypassed when results of the scan do not show any alarmed regions (e.g., the scan is clear). Level 2 scanning may be performed when results of the scan show one or more alarmed regions (e.g., the scan is not clear). Objects that pass Level 1 screening without any alarmed regions are referred to as Level 1 Clear, and objects that fail Level 1 screening (e.g., alarmed regions are present) are referred to as Level 1 Alarm. The first exit E-gate 1401 (e.g., clear E-gate) permits a Level 1 Clear individual to proceed without an operator intervention and a second exit E-gate 1402 (e.g., alarm E-gate) that guides a Level 1 Alarm passenger into the resolution zone 1410 for Level 2 screening. For the Level 1 Clear person, which indicates that a scan of the individual is clear, the first exit E-gate 1401 opens. For the Level 1 Alarm individual, which indicates that the scan of the individual alarms, the second exit E-gate 1402 opens to guide the individual into the resolution zone 1410.

In an embodiment, the screening station 1400 can include a first exit E-gate system that involves a single E-gate (e.g., the first E-gate 1401) used to let a Level 1 Clear person to proceed without an operator intervention. In an embodiment, the screening station 1400 can include a second exit E-gate system that involves two separate e-gates (e.g., the first E-gate 1401 and the second E-gate 1402). In the second exit E-gate system, the first exit E-gate 1401 (e.g., clear E-gate) can permit a Level 1 Clear individual to proceed without an operator intervention and the second exit E-gate 1402 (e.g., alarm E-gate) can guide a Level 1 Alarm individual into the resolution zone 1410 for automatic or manual Level 2 screening. The resolution zone 1410 is a holding area for a Level 2 screening person. Within the resolution zone 1410, an operator can quickly query the body scan result of the Level 2 screening person for a further investigation. According to one or more embodiments described herein, a remote operator can remotely perform additional evaluation of the individual using a video feed from an evaluation camera 1405.

In an embodiment, all the exit E-gates are closed before a next person is permitted into the scanner 704 for both the first and second exit E-gate systems. In an embodiment, the first and/or second exit E-gate system can be used with or without the exit guide light(s) and/or indicator (s) described herein. The first and/or second exit E-gate system can be controlled by the computing device 150 or another suitable system or device.

One or more of the embodiments described herein provide advantages over the prior art. For example, in one or more embodiments scanning throughput is improved where multiple individuals are scanned in succession because the individuals are able to achieve the target pose more quickly. As another example, operator intervention is reduced as individuals can pose themselves correctly without operator involvement. The scan can then begin automatically responsive to the target pose being achieved, which further reduces scan time because the scan does not need to be manually initiated. Further, rescans due to improper pose of the individual can be reduced because the target pose is achieved before scanning is initiated, thus reducing scanning system resources. Other improvements are also possible as is apparent from the description provided herein.

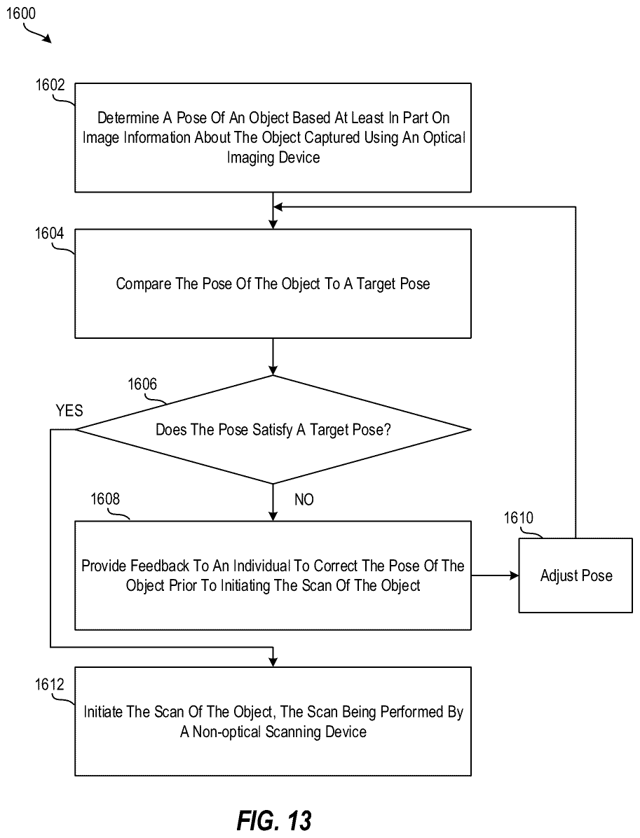

FIG. 13 is a flow diagram of a computer-implemented method 1600 for performing a scan of an object (e.g., an individual) according to one or more embodiments described herein. The method 1600 can be performed by any suitable system or device as described herein or the like. At block 1602, a pose of an object is determined based at least in part on image information about the object captured using an optical imaging device (e.g., the optical imaging device 602). The pose can be determined by the optical imaging device, by a processing system, or another suitable system or device. At block 1604, a processing system (e.g., the processing system 606) compares the pose of the object to a target pose. At block 1606, it is determined whether the pose satisfies the target pose. For example, the pose may be considered to satisfy the target pose if locations of identified joints of an individual or identified features of an object are within a threshold distance of target locations for the joints or features (e.g., a location of an elbow joint is within a threshold distance of a target location for the elbow joint). If the pose does not satisfy the target pose (block 1606 is “NO”), the method 1600 proceeds to block 1608, and the processing system provides feedback in real-time to an individual to correct the pose of the object prior to initiating the scan of the object. The individual can then adjust the pose at block 1610, and the method returns to block 1604 for continued execution. In some embodiments, the method 1600 may implement a time out such that the method 1600 terminates if the pose fails to satisfy the target pose at block 1606 for a defined period of time (e.g., 30 seconds, 1 minute, 2 minutes, 5 minutes, etc.). If the pose satisfies the target pose (block 1606 is “YES”), the processing system initiates the scan of the object, such as by sending a command to a non-optical scanning device (e.g., the non-optical scanning device 604), which performs the scan of the object.

Additional processes also may be included, and it should be understood that the process depicted in FIG. 13 represents an illustration, and that other processes may be added or existing processes may be removed, modified, or rearranged without departing from the scope of the present disclosure.

In describing example embodiments, specific terminology is used for the sake of clarity. Additionally, in some instances where a particular example embodiment includes multiple system elements, device components or method steps, those elements, components or steps may be replaced with a single element, component, or step. Likewise, a single element, component, or step may be replaced with multiple elements, components, or steps that serve the same purpose. Moreover, while example embodiments have been illustrated and described with references to particular embodiments thereof, those of ordinary skill in the art will understand that various substitutions and alterations in form and detail may be made therein without departing from the scope of the present disclosure. Further still, other aspects, functions, and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A system for performing a scan of an object, the system comprising:
a non-optical scanning device to perform the scan of the object;
an optical imaging device to capture image information about the object prior to performing the scan of the object; and
a processing system comprising:
a memory comprising computer readable instructions; and
a processing device for executing the computer readable instructions, the computer readable instructions controlling the processing device to perform operations comprising:
determining whether a pose of the object satisfies a target pose; and
responsive to determining that the pose of the object satisfies the target pose, causing the non-optical scanning device to perform the scan of the object.

2. The system of claim 1, further comprising a visual display device to display a visual representation of the pose of the object and a visual representation of the target pose.

3. The system of claim 2, wherein the operations further comprise:
responsive to determining that the pose of the object fails to satisfy the target pose, providing feedback on the display, the feedback indicating how the pose of the object fails to satisfy the target pose.

4. The system of claim 3, wherein the feedback is displayed prior to causing the non-optical scanning device to perform the scan of the object.

5. The system of claim 1, wherein the optical imaging device directly performs an estimation of the pose of object.

6. The system of claim 1, wherein the operations further comprise estimating the pose of object based at least in part on image data received from the optical imaging device.

7. The system of claim 1, wherein the optical imaging device includes a visible light imaging device that captures visible light images or an infrared (IR) imaging device that captures IR images.

8. The system of claim 1, wherein the optical imaging device includes a visible light imaging device that captures visible light and an infrared (IR) imaging device that captures IR images.

9. The system of claim 1, wherein the optical imaging device is used for depth estimation of the object.

10. The system of claim 1, wherein the non-optical scanning device is a millimeter-wave imager.

11. The system of claim 1, wherein determining whether the pose of the object satisfies the target pose comprises identifying a human form and at least one joint associated with the human form.

12. The system of claim 1, wherein the system further comprises a traffic flow device, and wherein the operations further comprise controlling the traffic flow device to provide traffic flow instructions.

13. The system of claim 12, wherein the traffic flow device is a light, and wherein the traffic flow instructions cause the light to selectively illuminate.

14. The system of claim 12, wherein the traffic flow device is a light, and wherein the traffic flow instructions set a color of the light.

15. The system of claim 1, wherein the operations further comprise:
extracting information of the object from images captured by the optical imaging device; and
transmitting the information of the object to the non-optical scanning device.

16. The system of claim 1, wherein the operations further comprise:
receiving a result of the scan from the non-optical imaging device;
controlling a downstream traffic flow gate in response to a result of the scan.

17. The system of claim 16, wherein controlling the downstream traffic flow gate comprises opening a gate to a resolution zone responsive to the scan indicating an alarmed region.

18. The system of claim 16, wherein controlling the downstream traffic flow gate comprises opening an exit gate responsive to the scan indicating no alarmed regions.

19. The system of claim 1, wherein the instructions further comprise initiating a rescan of the object responsive to the scan being failed.

20. A computer-implemented method for performing a scan of an object, the method comprising:
determining a pose of an object based at least in part on image information about the object captured using an optical imaging device;
comparing the pose of the object to a target pose;
responsive to determining that the pose of the object fails to satisfy the target pose, providing feedback to correct the pose of the object prior to initiating the scan of the object; and
responsive to determining that the pose of the object satisfies the target pose, initiating the scan of the object, the scan being performed by a non-optical scanning device.
